(19) United States
(12) Patent Application Publication
(10) Pub. No.: US 2015/0058211 A1
(43) Pub. Date: Feb. 26, 2015

(54) USER VALIDATION, AMOUNT-DUE VALIDATION, PAYMENT COLLECTION, AND PAYMENT PROCESSING SYSTEM AND METHOD THEREOF

(71) Applicant: PAYIT, LLC, Parkville, MO (US)

(72) Inventor: JOHN THOMSON, Parkville, MO (US)

(21) Appl. No.: 14/469,372

(22) Filed: Aug. 26, 2014

Related U.S. Application Data
(60) Provisional application No. 62/042,038, filed on Aug. 26, 2014.
(60) Provisional application No. 61/869,911, filed on Aug. 26, 2013.

(51) Int. Cl. G06Q 20/40; G06Q 20/10; G06Q 20/32

(52) U.S. Cl. CPC G06Q 20/4014; G06Q 20/3223; G06Q 20/102
USPC 705/40

(57) ABSTRACT

The systems and methods of the present invention allow users to perform various transactions using a mobile device. This is accomplished by building custom software to interact with a variety of hardware systems. Various transactions performed by the systems and methods of the present invention include collection and validation of various information. In some cases, information is obtained directly from the user. In other cases, information is obtained from a third party, such as a government agency. The system and methods of the present invention further improve upon the execution of transactions by including a unique system architecture and providing robust user and third-party interfaces.

### CROSS-REFERENCE TO RELATED APPLICATIONS

This application claims priority pursuant to 35 U.S.C. 119(e) to co-pending U.S. Provisional Patent Application Ser. No. 61/869,911, filed Aug. 26, 2013, and to co-pending U.S. Provisional Patent Application Ser. No. 62/042,038, filed Aug. 26, 2014, the entire disclosures of which are incorporated herein by reference.

### BACKGROUND OF THE INVENTION

The present inventive concept pertains to a system and method that is configured to validate a user of the system, validate one or more amounts due from the user to one or more merchants, collect payment of the one or more amounts due from the user to the one or more merchants, and process the payment so that the one or more merchants receive the payment. The system is capable of being accessed by the user via a mobile device and/or the internet.

### SUMMARY OF THE INVENTION

The present inventive concept described herein provides a unique system and method to validate information, and collect and process payments. The present inventive concept generally includes one or more data warehouses and one or more communication portals or interfaces, e.g., a user interface, a merchant interface, a financial institution interface, and an administrator interface, each in wired or wireless communication with each other.

In some embodiments the user interface is a mobile device, e.g., a smart phone with an application configured to at least partially perform the steps of the present inventive concept as provided herein.

In some embodiments the mobile device includes a scanning device, e.g., a camera, operable to scan or photograph one or more objects, e.g., identification information, e.g., a license plate, a drivers license, a traffic citation, a bill or invoice, a credit card of the user, and/or a check of the user. In some embodiments the one or more objects are issued or related to the one or more merchants. In some embodiments the one or more objects are issued or related to a financial institution and/or the user, e.g., a credit card, a check associated with a checking or savings bank account.

In some embodiments the system is configured to allow for and process present and/or future payments, e.g, renewals on a predetermined reoccurring date, e.g., annually.

In some embodiments the system, upon approval of a payment by the user, provides verification of the payment to the user, e.g., via a receipt of the payment, via transmission of new/replacement license plate tags, and/or the like.

In some embodiments the system is configured to furnish reports to the one or more merchants such as, but not limited to, insights for compliance, insights for audit and oversight, insights for decision support, insights for the foundation for engagement, and/or program marketing services.

In some embodiments the system is configured to scan, e.g., via use of a camera on a smart phone to scan government documents, e.g., using OCR technology, such as a DMV form, ticket, etc. In some embodiments the system is configured to link the scanned information to one or more databases in communication therewith, and retrieve the linked information therefrom to validate information, e.g., the user identity, the user owes a fee, the user has funds to pay the fee, and the fee is paid. In some embodiments the information from the government systems include motor vehicle information, citation information and the like and in some embodiments is linked via direct integration. In some embodiments the information used by the system includes one or more barcodes/QR codes and/or an actual license plate. The user, via the system of the present inventive concept, is able to enter in a code to the system and manually pull up a record via the same integration.

In some embodiments the system is configured to verify information. Once data is retrieved from government database in real time, the information is displayed by the present inventive concept so that the user can verify information.

In some embodiments the system is configured to collect and process payment. The user, via the system of the present inventive concept, is able to select one or more payment options, e.g., 1 or 2 year renewal and/or credit card, paypal, etc. as payment mechanism. The user is able to enter information into secure PCI compliant gateway of the system of the present inventive concept, or select from previously entered credit card information, e.g., information saved by the system in a database of the system. The user is able to confirm payment and receive payment verification information. The user is then able to receive verification of process completion, e.g., renewal sticker in mail or citation paid, etc. The system of the present inventive concept is able to store receipt information, e.g., in a database.

In some embodiments the mobile device of the user configured for use with the system of the present inventive concept is a mobile application running on a mobile device, e.g., iOS, Android, and/or other like device. In various embodiments the server of the present inventive concept, e.g, the server side app, is Ruby on Rails, data store, and/or the like.

The aforementioned is achieved in some embodiments of the present inventive concept by providing a system for user validation, amount-due validation, payment collection, and/or payment processing system. The system of some embodiments includes a database configured to receive and store information related to a user. In some embodiments the system includes a processor. In some embodiments the system includes a user interface configured to be accessed by the user. In some embodiments the user interface is in communication with the processor.

In some embodiments the user interface is configured to allow a user to at least one of (i) validate an identity of the user based on the information stored in the database, (ii) validate an amount due from the user based on the information stored in the database, (iii) collect the amount due from the user as a payment, and (iv) process the payment.

In some embodiments the amount due is transferred to another user of the system. In some embodiments the system is implemented via an application running on a mobile device of the user.

In some embodiments the aforementioned is achieved in one aspect of the present inventive concept by providing a method of validating a user, validating an amount-due from the user, collecting payment from the user, and/or processing the payment from the user. In some embodiments the method includes the step of receiving and storing information in a database. In some embodiments the information is related to the user. In some embodiments the database is in communication with a processor.

In some embodiments the method includes the step of retrieving at least a portion of the stored information from the database via a user interface configured to be accessed by the user. In some embodiments the user interface is in communication with the processor.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 (FIG. 1A through FIG. 1D) illustrates a flow chart of an exemplary user experience of the present inventive concept.

FIG. 2 illustrates an exemplary embodiment of the present inventive concept.

### DETAILED DESCRIPTION OF THE DEVICE

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

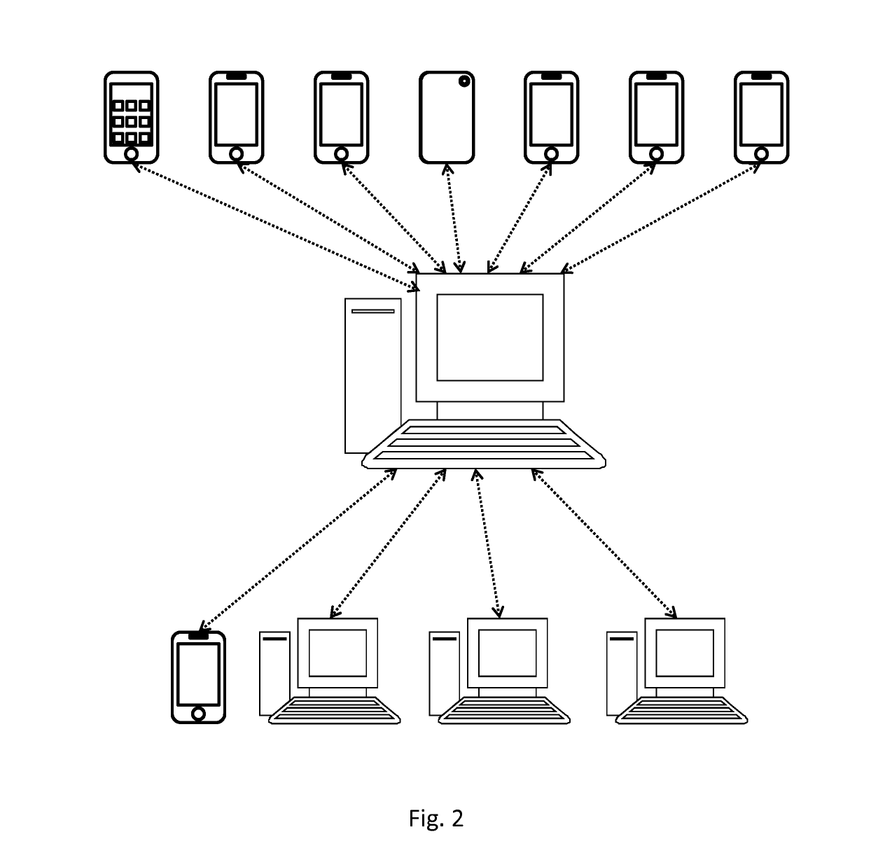

Referring to FIG. 2 an embodiment of the present invention is shown including a central computer/platform 300 that includes a central processor 30 and a central database 40 accessible by central computer 300. The central computer 300 is in communication with a plurality of third party systems and a plurality of mobile devices 200. Each third-party system includes a third-party interface 50 while each mobile device 200 provides a user interface 20, respectively for communicating with associated interfaces of the central computer. In this way, the central computer 300 serves as a central hub of the system 10 with spokes of communication extending to a plurality of users and third parties. The central computer includes a computer program of the inventive concept that includes instructions to the central processor for communicating with the third party systems and mobile devices to complete payments from the users of the mobile devices to the agencies/entities/persons of the third party systems pursuant to work flows associated with the third party systems. The central processor includes work flow from various and often unrelated third parties and enables workflows that are often dependent upon one another (e.g. vehicle registration and payment of yearly personal property taxes that must be completed before registration can be accomplished), although accomplished through separate third parties, to be integrated together via the system of the inventive concept and accomplished together. It will be appreciated that the detailed disclosure provided herein refers broadly to a number of method steps and/or procedures that will be understood to be performed by the central computer, mobile devices and or third party systems via software instructions of the inventive concept. Furthermore, it will be appreciated that information discussed below as being obtained, received, entered, etc. by system 10 in various embodiments will be obtained through interfaces, input devices, and/or databases of or accessible by the central processor.

The system 10 of the present invention includes at least one user interface 20. In some embodiments, a mobile device 200 having data input and output hardware is configured to operate as a mobile user interface 20. For instance, in some embodiments of the present invention, a smartphone 200 having a display screen 210 and input keys 212 operates as a mobile user interface 20. In some embodiments of the mobile device 200, the display screen 210 is capable of serving as both a data input and a data output device. In some such embodiments, the input keys 212 are integrated with the display screen 210. In other embodiments of the mobile device 200, the input keys 212 are independent of the display screen 210.

In some embodiments of the present invention, a software installation package is deployed to load a software application onto a mobile device 200. In various embodiments, installation of the software package is done via various installation procedures depending on the kind of operating system in use. By running the application on the mobile device 200, the mobile device 200 provides a mobile user interface 20.

In some embodiments, the mobile device 200 includes an image capturing device 220, such as a camera, that is operable to scan or photograph one or more objects. In other embodiments, the mobile device 200 includes a data storage device that is capable of storing data, such as scanned images or digital photographs. In still other embodiments, the mobile device 200 includes a communication device, for wired and/or wireless communication, that is capable of receiving data from an external image capturing device 220 and/or an external data storage device. In any of the above embodiments of the mobile device 200, or in any combination of the above embodiments of the mobile device 200, the user interface 20 includes an input for obtaining data from the mobile device 200. In other such embodiments, the user interface 20 includes a mechanism for submitting data to the mobile device 200 for storage on the data storage device.

In some embodiments of the present invention, the system 10 includes at least one central data processor 30, such as central computer 300. In some such embodiments, the central data processor 30 is configured to be in data communication with at least one user interface 20. In other such embodiments, the central data processor 30 is configured to be in data communication with a third party, such as a government website.

In some embodiments of the present invention, the central processor 30 is in data communication with a central database 40. The central database 40 is configured to receive information from the central data processor 30 and store the information for later retrieval. The central data processor 30 is configured to search through information stored on the central database 40 and retrieve information that satisfies a search criteria. In some embodiments, the database 40 is at least partially stored on a central computer 300.

In some embodiments, the database 40 stores information related to a user. In other embodiments at least a portion of data related to a user is stored locally via a database that is only accessible to the user's mobile device and not accessible to the central processor 30. Examples of the information include a user's credentials, a user's transaction history, and/or a variety of other user specific information. For instance, in some embodiments the information includes data, such as a document or a digital photograph, that was previously received from a user and/or from a third party, such as a government agency, a merchant, a financial institution, an administrator of the system, a different user, and/or any other third party.

In some embodiments, the mobile device 200 includes a mechanism for determining the geographic location of the mobile device 200. In some such embodiments, the mobile device 200 communicates the geographic location to the central processor 30. The central processor 30 uses the geographic location to obtain search criteria. For instance, if a user is located in Jackson County, Mo., the central processor 30 searches the central database 40 for information pertaining to Jackson County, Mo. and the surrounding area. The central processor 30 then communicates at least part of the search results to the user interface 20 so as to inform the user of services provided by the system that may pertain to the user. For instance, in various embodiments, the user interface includes information pertaining to the Missouri Department of Motor Vehicles, the Missouri Department of Conservation, the Kansas Turnpike Authority, and/or a variety of other agencies and/or organizations.

In some embodiments of the present invention, a software installation package is deployed on a central computer 300. In some embodiments, the central computer 300 includes and/or is in data communication with a central processor 30 and/or a central database. In various embodiments, installation of the software package is done via various installation procedures depending on the kind of operating system in use. In some such embodiments, installation of the software package on the central computer 300 enables the computer to be used as an administrator interface for the system. In other such embodiments, by running the software on the central computer 300, the computer 300 serves as a central processor 30 and/or a central database 40.

In some embodiments of the present invention, a software installation package is deployed by a third party. In various embodiments the third party is a merchant, a financial institution, a government agency, and/or a variety of other third parties. In various embodiments, installation of the software package is done via various installation procedures depending on the kind of operating system in use. In some such embodiments, installation of the software package on a computer and/or a mobile device enables the computer and/or the mobile device to be used as a third-party interface 50, such as a merchant interface 50, a government agency interface 50, a financial institution interface 50, and/or any other third party interface 50.

Various embodiments of the present invention include various features and subroutines. Operation of many of the features and subroutines include communication between the central processor 30 and a user interface 20. More specifically, the communication between the user interface 20 and the central processor 30 enables a user to provide information to, or obtain information from, the system 10 and its associated database(s).

Prior to providing information to, or obtaining information from, the system 10, a user gains access to the system 10. A user gains access to the system 10 through a user interface 20. The user interface 20 is configured to be accessed by a user.

In some embodiments, the system requires the user to provide credentials prior to allowing the user to gain access to the user interface 20 and/or the system 10. In other embodiments, the system 10 requires the user to provide credentials prior to allowing the user to use the system 10 to perform a specific task. In one such embodiment, the specific task includes providing information to the system 10. In another such embodiment, the specific task includes obtaining information from the system 10.

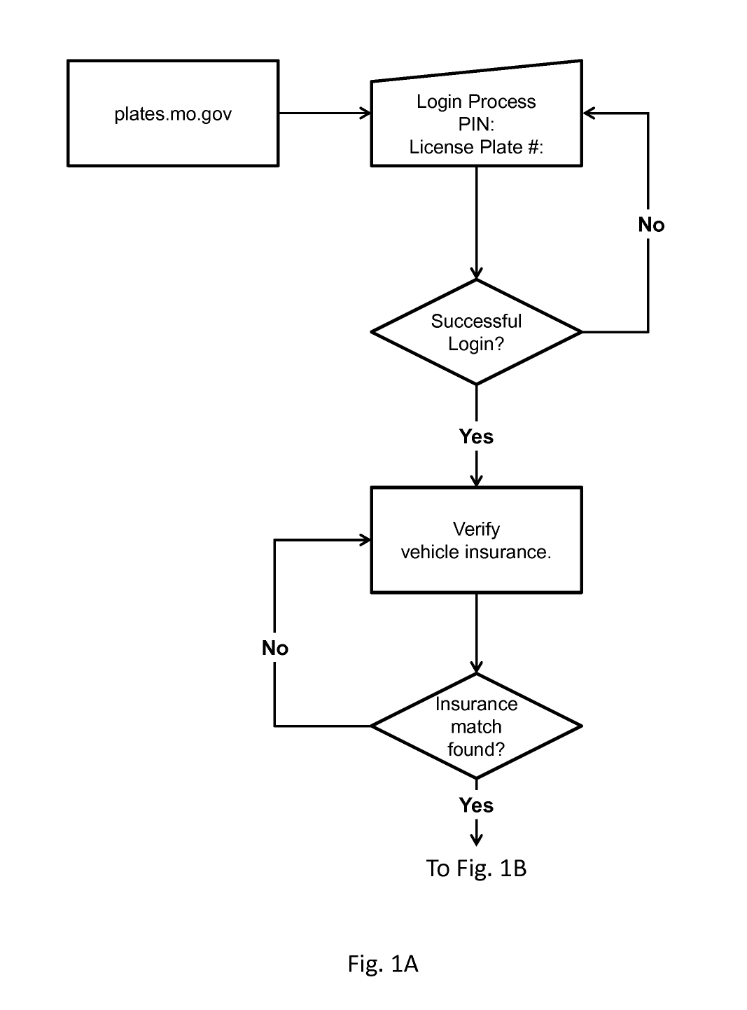

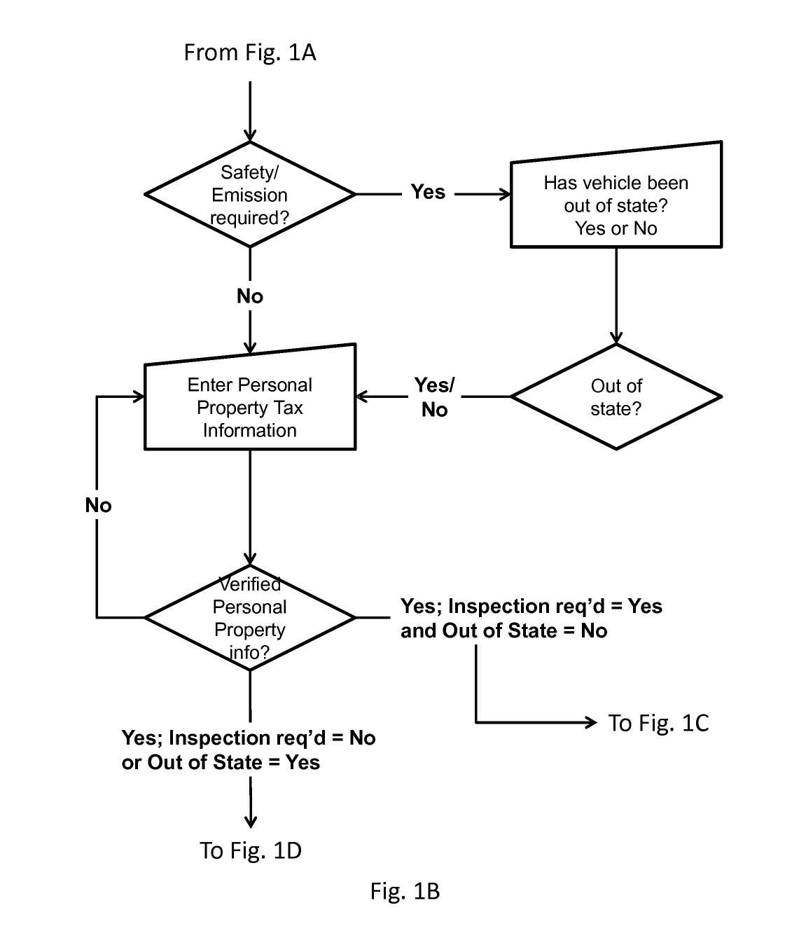

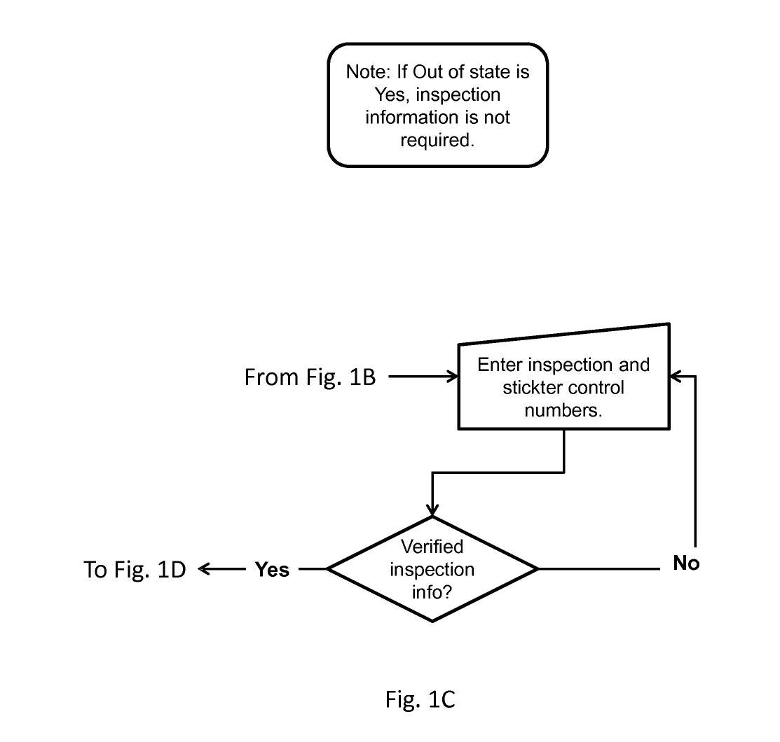

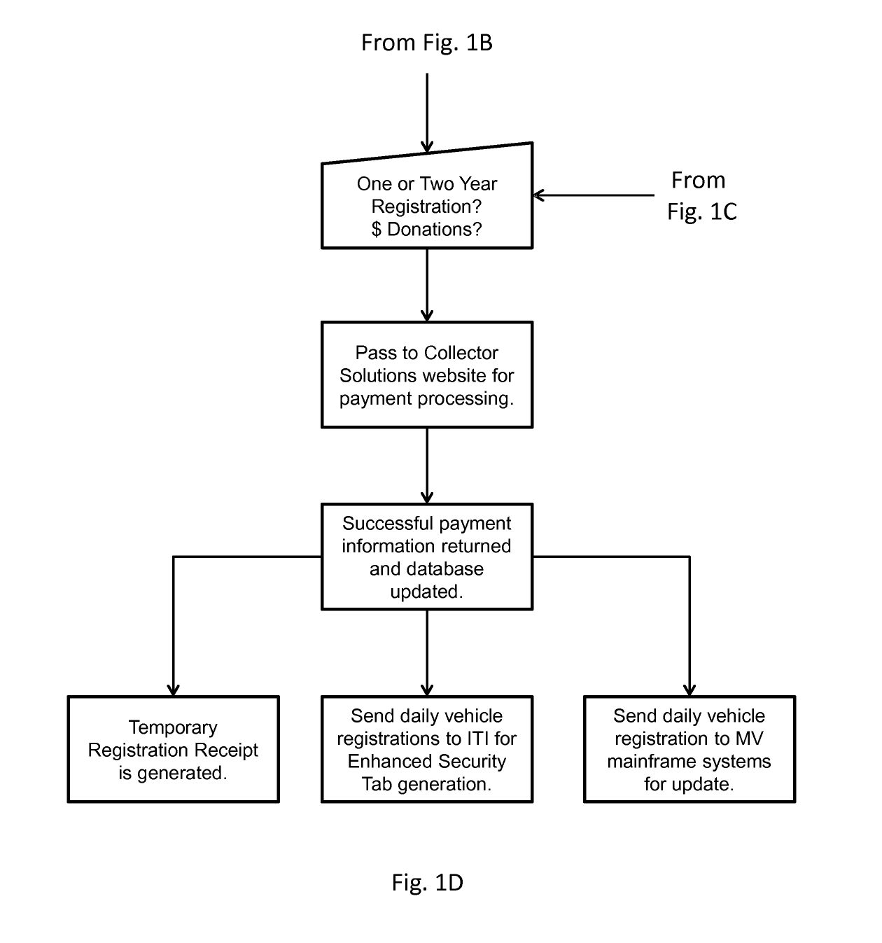

In some embodiments, a user's credentials include an account name and a password, although in various other embodiments a variety of credentials are used. For example, the embodiment of the system 10 represented by FIG. 1 requires a user to input a license plate number and a pin number prior to using the system 10 to perform a specific task.

Upon gaining access to the system 10, the user interface 20 enables a user to utilize the system 10 to perform a variety of tasks. For example, in various embodiments, the user interface 20 enables a user to utilize the system 10 to make a payment, to obtain verification of a payment, to provide information to a third party, to obtain information from a third party, and/or to perform a variety of other tasks.

In some embodiments, the third party is a government agency. In some such embodiments, the system 10 is integrated with at least a portion of the agency's system. In other embodiments, the user interface 20 is integrated with the agency's entire landscape of backend systems. In various embodiments, the user interface 20 enables a user to utilize a mobile application that is installed on a mobile device 200 to perform functions that would otherwise require the user to access a website, such as a mobile-enabled website. In other embodiments, the user interface 20 enables a user to utilize the mobile application to perform functions that cannot be accomplished with any website, including a mobile-enabled website. In some such embodiments, the mobile application allows the user of the application to perform functions with multiple unrelated agencies and to combine workflows that are dependent upon one another (although often unrelated) to be performed simultaneously and/or in sequences with each other through the application to allow completion of all dependent functions.

In some embodiments, the system 10 includes a scalable, open and flexible platform. As such, some embodiments of the system include multiple integration interfaces for integration with at least a portion of a plurality of agency systems. For instance, in some embodiments, first and second integration interfaces integrate the system 10 with at least a portion of the back-end systems of state and county agencies, respectively. In some such embodiments, the system 10 enables a user to renew a state license and pay county property taxes in one transaction using a software application that is loaded onto a mobile device 200. In other such embodiments, the system 10 enables a user to obtain an official document from one agency system, such as a receipt, license, permit, report, or the like, and provide the document to another agency system. In still other such embodiments, the system 10 enables a user to store official documents in one location, such as within a software application or database accessible by the software application.

In still other embodiments, the open and flexible platform of the system 10 enables a government agency to provide a variety of services within the digital architecture of the system 10. In some such embodiments, the services are directly related to a user's traditional interactions with the agency. In other such embodiments, the services are similar to those services provided by a website. In still other such embodiments, the services are unrelated to a user's traditional interactions with an agency and/or are completely unique from those services provided by a website. For instance, in one embodiment, the system 10 enables a user to pay a vehicle registration fee without requiring the user to take a number, mail documents, or navigate a government website.

FIG. 1 shows a flow chart demonstrating one method of using the system 10 to pay a vehicle registration fee. The flow chart tracks various steps taken by the central processor to complete the transaction using the system 10. As a preliminary step, the user of the mobile application of the inventive concept provides credentials through the application to gain access to the system 10 or to one or more specific work flows of system 10. In FIG. 1, the user's credentials consist of a license plate number and a pin number. The license plate number is intended to be a method of identifying a user and a vehicle while the pin number is intended to be a secure method of verifying the identification of the user. In some embodiments, the pin number is generated by a government agency and provided to the user. In other embodiments, the pin number is provided by the system to the user. In still other embodiments, the pin number is generated by the user. It is understood that in yet other embodiments, a license plate number and/or a pin number is not used at all. Instead, another identification method and/or another secure method of verifying identification is used.

After a user gains access to the system 10 (or work flow(s)), the first step of the method shown in FIG. 1 is for the system 10 to verify that a vehicle is insured. In some embodiments, the central process of system 10 has access to insurance information related to the vehicle, such as databases of insurance agencies, or data stored in a database accessible by the system 10 evidencing insurance (such as an uploaded copy of an insurance card). In such an embodiment, the central processor of system 10 searches for a vehicle insurance verification that matches the intended vehicle registration. For instance, in one embodiment of the example provided in FIG. 1, the central processor of system 10 uses the license plate number of the vehicle to search insurance agency databases for an insurance policy for a vehicle having the same license plate number. It is understood that, in other embodiments, other methods of matching an insurance policy to a vehicle will be used.

In the event that an insurance match is not found for a vehicle, the embodiment of the central processor shown in FIG. 1 prevents the user from proceeding with the registration process. In some such embodiments, the central processor of system 10 allows a user to input vehicle insurance information so that a match can be found. In other such embodiments, the central processor of system 10 obtains vehicle insurance information from a third party, such as an insurance company and/or a government agency.

Upon verifying that a vehicle is insured, the central processor of system 10 represented by FIG. 1 determines whether or not an inspection, such as a vehicle safety inspection and/or a vehicle emission test, is required. In some such embodiments, the determination is based on information received from a third party and/or stored in one or more databases accessible by the system 10. For instance, in some embodiments a government agency system or database will provide the central processor of system 10 with an indication of whether or not an inspection has already been done on a particular vehicle or whether it is even required for a particular make, model, or year of vehicle. In other such embodiments, the determination is based on information received from a user. For instance, a user may indicate through the mobile application that the vehicle is located out of state and/or upload evidence of inspection.

If an inspection is required, the central processor of system 10 represented by FIG. 1 requires verification that an inspection was completed. In some embodiments, the system 10 allows a user to input an inspection verification number and/or a sticker control number as verification that an inspection has been completed. In other embodiments, the central processor of system 10 obtains inspection verification information from a system interface of a third party, such as a mechanic and/or a government agency.

The flow chart in FIG. 1 also shows the step of entering personal property tax information. In some embodiments, the system 10 enables a user to enter the tax amount directly into the mobile application of system 10 and such information is communicated to the central processor. In other embodiments, the system 10 obtains the tax amount from a system interface of a third party, such as an accounting firm or a government agency. In still other embodiments, the system 10 calculates the tax amount based on information received from a system interface of a third party, such as an accounting firm and/or a government agency. It is understood that in other embodiments, the system 10 includes one or more similar steps of entering/receiving information for the purpose of completing a transaction.

The flow chart in FIG. 1 also shows the step of verifying personal property tax information. In some embodiments, the central processor of system 10 verifies the tax amount by comparing it to a previously received tax amount value (e.g. that is stored in a database or otherwise communicated to the central processor). In other embodiments, the system 10 requires the user to verify the tax amount value. In still other embodiments, the system 10 verifies the tax amount by comparing it to a calculated amount, with the calculated amount being based on information received from a third party system interface to the central processor, such as an accounting firm and/or a government agency.

The flow chart in FIG. 1 also shows the step of selecting a one or two year registration period by the user via an input in the mobile application. The choice is based on Missouri's practice of allowing its citizens to pay vehicle registrations for either one or two years at a time. For other states where this option is not available, the system 10 automatically selects an appropriate registration period.

The flow chart in FIG. 1 also shows the step of selecting through the mobile application whether or not to include a donation with the transaction. In some embodiments, the donation goes directly to the agency involved in the transaction. In other embodiments, the system 10 allows a user to select from a list of agencies and/or organizations to receive the donation.

Next, the flow chart in FIG. 1 shows that information is passed from the central processor to a “Collector Solutions” website/subroutine/system interface for a payment to be processed. In some embodiments, the “Collector Solutions” website is part of and/or administered by the system 10. In other embodiments, the “Collector Solutions” website is administered by a third party, such as a government agency, an independent collection agency, and/or any other third party.

Upon successful completion of a payment process, information pertaining to the transaction, including information pertaining to a successful payment, is generated by and/or provided to the system 10 from the Collector Solutions system. In some embodiments the system 10 updates the central database 40 with information pertaining to the transaction. In other embodiments, the system 10 enables a user to generate a receipt for the transaction. In some embodiments, the receipt is merely a temporary receipt. In other embodiments, the receipt is an official receipt. In some embodiments the receipt is stored in a database of or accessible by the user's mobile device, such as via the mobile application.

Finally, the flow chart in FIG. 1 shows that information is sent to third-parties by the central processor. For instance, vehicle registration information is sent to an ITI system for Enhanced Security Tab generation (e.g. generation the renewal sticker on a vehicle license plate). Additionally, the vehicle registration information is also sent to MV (motor vehicle department) mainframe systems for update.

In other embodiments, a variety of information is sent to a user (e.g. through the mobile application) and/or to a third party (e.g. through an interface) by the central processor. In some such embodiments, the system automatically sends the information. In other such embodiments, the information is sent upon a user's request. In still other such embodiments, the information is sent upon a third party's request and a user's approval. In some embodiments, the system 10 or the third party system to which a payment has been made generates a hard copy of information (for example a license or renewal tag, etc.) that is mailed to the user utilizing information transmitted from the mobile application through the central processor to the third party system.

Various embodiments of the computer programs, devices, systems, and methods of the present invention are implemented in hardware, software, firmware, or combinations thereof using the computer programs of the invention, which broadly comprise server devices, computing devices, and communication networks. Various embodiments of the server devices include computing devices that provide access to one or more general computing resources, such as Internet services, electronic mail services, and data transfer services, and the like. In some embodiments the server devices also provides access to a database that stores information and data, with such information and data including information and data necessary and/or desirable for the implementation of the computer program, devices, systems, and methods of the present invention.

Various embodiments of the server devices and the computing devices include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard disk drives, network attached storage, or a separate storage network.

Various embodiments of the computing devices specifically include communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas and/or via a keyboard or other input device to provide information to the user control interface.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of the computer program of the present invention run on computing devices. In other embodiments the computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments information is stored on a memory element associated with the server device, such that the information is remotely accessible to users of the computer program via one or more computing devices. Alternatively, in other embodiments the information is directly stored on the memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using the computer program will actually be performed by one or more computers, processors, or other computational devices, such as the computing devices and/or server devices, independently or cooperatively executing portions of the computer program.

A user of the computer program is capable of accessing various embodiments of the present invention via an electronic resource, such as an application, a mobile “app,” or a website. In certain embodiments, portions of the computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the Internet) with the computing device.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, various embodiments of the present technology include a variety of combinations and/or integrations of the embodiments described herein.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

I claim:

1. A payment processing system, the system comprising:
a processor;
a database accessible by said processor and configured to receive and store information related to a plurality of electronic payment work flows;
a plurality of integration interfaces operably connecting said processor to processing systems associated with each of said plurality of electronic payment work flows; and
a user application interface operably connecting said processor to an application on a remote user device;
wherein said processor communicates payment work flow information of at least one of said plurality of electronic payment work flows to said user application and receives user information required pursuant to said payment work flow information to complete a payment transaction; and
wherein said processor communicates said user information to a processing system associated with said at least one of said plurality of electronic payment work flows to complete said payment transaction.

2. The system as claimed in claim 1 wherein said plurality of electronic payment work flows includes a first payment work flow and a second payment work flow that requires completion of said first payment work flow prior to completion of said second payment work flow and wherein said processor integrates said first and second work flows to complete appropriately said second payment work flow.

3. A mobile payment processing system, the system comprising:
a mobile application operating on a device of a user;
a database accessible by said mobile application to store information regarding said user;
a user application interface operably connecting said mobile application to a payment platform configured to receive and store information related to a plurality of electronic payment work flows and including a plurality of integration interfaces operably connecting said platform to processing systems associated with each of said plurality of electronic payment work flows;
wherein said mobile application receives from said platform payment work flow information of at least one of said plurality of electronic payment work flows to transmits to said platform user information required pursuant to said payment work flow information to complete a payment transaction by communicating said user information from said platform to a processing system associated with said at least one of said plurality of electronic payment work flows to complete said payment transaction.

4. The system as claimed in claim 3 wherein said plurality of electronic payment work flows includes a first payment work flow and a second payment work flow that requires completion of said first payment work flow prior to completion of said second payment work flow and wherein said first and second work flows are integrated together to complete appropriately said second payment work flow.

5. A method of collecting payment from the user and processing the payment from the user, the method comprising the steps of:
storing in a database information related to a plurality of electronic payment work flows;
transmitting from a processor via a user application interface operably connecting said processor to an application on a remote user device information regarding at least one of said plurality of electronic payment work flows;
receiving at said processor from said application information required pursuant to said at least one of said plurality of electronic payment work flows to complete a payment transaction;
communicating said information to a processing system associated with said at least one of said plurality of electronic payment work flows to complete said payment transaction.

6. The method as claimed in claim 5 wherein said plurality of electronic payment work flows includes a first payment work flow and a second payment work flow that requires completion of said first payment work flow prior to completion of said second payment work flow and wherein said first and second work flows are integrated together by said processor to complete appropriately said second payment work flow.
